(19) United States
(12) Patent Application Publication
(10) Pub. No.: US 2017/0139666 A1
(43) Pub. Date: May 18, 2017

(54) METHOD FOR IDENTIFYING A PLURALITY OF DEVICES THAT CAN BE CONNECTED TO AT LEAST ONE REMOTE UNIT

(71) Applicant: DEVIALET, Paris (FR)

(72) Inventors: Pierre-Emmanuel CALMEL, Le Chesnay (FR); Charles COQUERET, Paris (FR); Maxime LEBLANC, Vitry Sur Seine (FR)

(73) Assignee: DEVIALET, Paris (FR)

(21) Appl. No.: 15/309,881

(22) PCT Filed: Apr. 16, 2015
(86) PCT No.: PCT/EP2015/058305

§ 371 Date: Nov. 9, 2016

(30) Foreign Application Priority Data
Apr. 17, 2014 (FR) 1453508

(51) Int. Cl. G06F 3/16; H04R 29/00

(52) U.S. Cl. CPC G06F 3/165; H04R 29/007

(57) ABSTRACT

Devices connected to a remote unit, each device storing at least one identifier of the device, and at least one configuration parameter representative of a configuration of the device, and a control set adapted for remotely controlling the devices, the control set comprising an interface. The method comprises selecting, by a user, any of the configuration parameters by the interface, detecting, by the control set, that the configuration parameter is selected and providing an identification parameter of the device corresponding to the configuration parameter. Transmitting, by the control set, a signal requesting identification containing the identification parameter, receiving, by each device, the signal and the identification parameter, comparing, by each device, the received identification parameter with the stored identifier to obtain a comparison result, and emitting by the device a sound or a visual signal if the comparison result is that the received identification parameter corresponds to the identifier.

### CROSS-REFERENCE TO RELATED APPLICATIONS

This application is a U.S. National Phase Application under 35 U.S.C. §371 of International Patent Application PCT/EP2015/058305, filed Apr. 16, 2015, which claims priority to French Patent Application No. 1453508, filed Apr. 17, 2014. The entire contents of these applications are hereby incorporated by reference.

### FIELD OF THE INVENTION

The present invention relates to a method using a plurality of devices which may be connected to a remote unit, and a set for controlling the devices comprising at least one man-machine interface adapted for allowing a user to configure the devices.

The invention also relates to a corresponding installation.

### BACKGROUND

Such devices are so called “smart” devices, i.e. capable of operating according to several configurations, notably depending on the location where they are found.

As these devices are generally sufficiently similar to each other structurally so as to be relatively indiscernible for a user, the question is posed of managing to identify them individually when a user seeks to configure them.

Traditionally, such devices were connected to the remote unit through a standard wired network. It was then possible to individually identify the devices by physically following the wired connections. However, such a method is tedious and does not guarantee against certain poor internal connections to the remote unit.

In any case, such a method is no longer possible if the devices are connected to the remote unit in an indiscriminate way for a user, for example through a protocol compliant with the IEEE 802.11 standard, i.e. “wifi”, or by wired network of the Ethernet or PLC (acronym for “power-line communications”) type.

### SUMMARY OF THE INVENTION

An object of the invention is therefore to provide a method allowing a user to easily identify the device which he/she is configuring, in particular in the case when the devices are structurally similar to each other, and without a display screen for a configuration parameter which the user would be modifying.

For this purpose, the object of the invention is a method using:
a plurality of devices which may be connected to at least one remote unit, each device comprising a memory adapted for storing at least one identifier of the device, and at least one configuration parameter representative of a configuration of the device, and
a control set adapted for remotely controlling the devices, the control set comprising at least one man-machine interface,

the method further comprising the following steps:
selection by a user of any of the configuration parameters by means of the man-machine interface,
detection by the control set that said configuration parameter is selected and providing through the control set a parameter for identifying the corresponding device to said configuration parameter,
transmission with the control set of a signal for requesting identification containing the identification parameter,
reception through each device of the signal and the identification parameter,
comparison by each device of the identification parameter received with the identifier contained in the memory of said device for obtaining a comparison result, and
emission by the device of a sound or a visual signal if the comparison result is that the received identification parameter corresponds to said identifier.

According to particular embodiments, the method comprises one or several of the following features, taken individually or according to all the technically possible combinations:
the devices of said plurality of devices have a similar external aspect with each other for the user;
each device of said plurality of devices is without a screen for displaying the configuration parameter of said device;
each of the devices of said plurality of devices comprises an acoustic chamber;
each device comprises at least one membrane able to emit sound waves, the visual signal comprising beats of the membrane which may be detected by the eye of the user;
the beats of the membrane have a non-zero frequency and less than or equal to 20 Hz, preferably less than or equal to 15 Hz; and
the selected configuration parameter is a label for identifying the device intended for the user, an operating parameter of the device, or a position parameter of the device relatively to at least one other of the devices of said plurality of devices.

The invention also relates to an installation comprising:
a plurality of devices which may be connected to at least one remote unit, each device comprising a memory adapted for storing at least one identifier of the device, and at least one configuration parameter representative of a configuration of the device, and
a set for remote control of the plurality of devices, the control set comprising at least one man-machine interface adapted so that a user selects any of the configuration parameters,

the control set being adapted for:
detecting that a user selects the configuration parameter,
providing a parameter for identifying the device for which the configuration parameter is selected, and
sending a signal for request of identification containing the identification parameter,

each device being adapted for:
receiving the signal and the identification parameter,
comparing the received identification parameter with the identifier contained in the memory of said device and obtaining a comparison result, and
emitting a sound or a visual signal if the comparison result is that the received identification parameter corresponds to said identifier.

### BRIEF DESCRIPTION OF THE DRAWINGS

The invention will be better understood upon reading the description which follows, only given as an example and made with reference to the appended drawings, wherein:

FIG. 1 is a schematic view illustrating a facility according to the invention, and

FIG. 2 is a detailed view schematically showing one of the devices illustrated in FIG. 1.

### DETAILED DESCRIPTION OF THE INVENTION

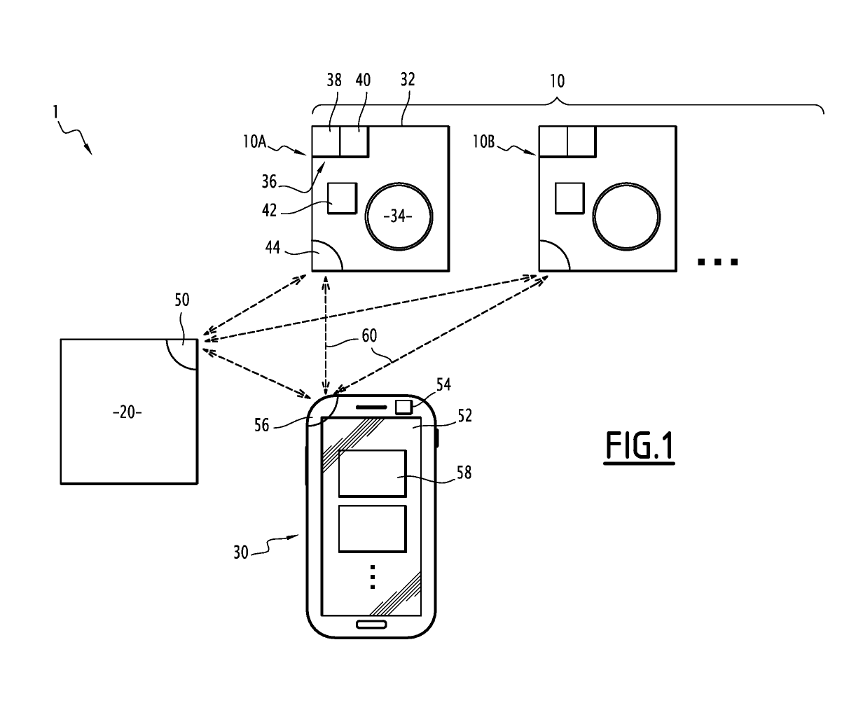

With reference to FIG. 1, an installation 1 according to the invention is described.

The installation 1 comprises a plurality of devices 10, a remote unit 20 which for example is a server, and a control set 30 adapted for individually configuring the plurality of devices 10.

The installation 1 is for example an acoustic installation located in a room or a performance hall (not shown).

The plurality of devices 10, in the example illustrated in FIG. 5, comprises two devices 10A and 10B which are structurally similar to each other.

Alternatively (not shown), the plurality of devices 10 comprises more than two devices.

As the devices of the plurality of devices 10 are structurally similar to each other, only the device 10A will be described in detail hereafter.

The device 10A is for example an acoustic chamber, advantageously intended to be located in a given location of the aforementioned room or hall.

The device 10A may advantageously be connected to the remote unit 20 through electromagnetic waves, for example with a protocol according to the IEEE 802.11 standard, or through a wired connection, of the Ethernet or PLC type (acronym of “power-line communication”).

Alternatively (not shown), the device 10A is a temperature sensor or any other home automation sensor known to one skilled in the art, intended to be located in a given room of a more vast assembly (not shown) such as an apartment.

The device 10A comprises a box 32 and at least one loudspeaker 34 positioned in an aperture of the box. The device 10A further comprises a memory 36 adapted for storing at least one identifier 38 of the device 10A and at least one configuration parameter 40 representative of a configuration of the device 10A, a processor 42, and a communication unit 44 adapted for exchanging pieces of information with the remote unit 20 and with the control set 30.

The box 32 is of any shape, for example parallelepipedal or spherical. The box 32 is advantageously without any screen for displaying the configuration parameter 40 of the device 10A.

The loudspeaker 34 is of a type known per se to one skilled in the art. The loudspeaker 34 for example includes a chassis 46 attached on the box 32, and a mobile membrane 48 relatively to the chassis 46 and adapted for emitting sound waves.

The loudspeaker 34 is further adapted for imparting to the membrane 48 beat movements detectable to the eye by a user.

Advantageously, the beat movements have a non-zero frequency and less than or equal to 20 hertz, preferably less than or equal to 15 hertz.

The beat movements advantageously have an amplitude A along an axis D of the loudspeaker 34 comprised between 0.1 and 50 mm, advantageously between 1 mm and 20 mm.

The axis D is for example defined as the axis of one or several coil(s) (not shown) used for displacing the membrane 48, or else as an axis of symmetry of the membrane 48 at rest.

The identifier 38 of the device 10A is for example a series number, or any other intrinsic piece of information of the device 10A and allowing it to be distinguished from the device 10B.

The configuration parameter 40 is for example an identification label of the device 10A intended for the user, such as a name. For example, the configuration parameter 40 of the device 10A is the label “left loudspeaker”, while the configuration parameter of the device 10B is the label “right loudspeaker”.

The processor 42, when it executes a piece of software for operating the device 10A, is adapted for reading in the memory 36, in order to exchange signals with the communication unit 44 and for sending electric signals to the loudspeakers 34, said signals being transformed into sound waves by the loudspeaker.

The communication unit 44 is advantageously adapted for communicating according to a protocol compliant with the IEEE 802.11 standard, i.e. wifi.

The remote unit 20 is for example a server. The remote unit 20 comprises a communication unit 50 adapted for exchanging signals with the communication units 44 of the devices 10A, 10B.

The pieces of information emitted by the communication unit 50 are for example electromagnetic signals intended to be transformed into sound waves by the plurality of devices 10. Optionally, the communication unit 50 is adapted for receiving pieces of information from the communication units 44 of the plurality of devices 10.

Advantageously, the communication unit 50 is able to communicate with the control set 30 in a unidirectional or bidirectional way.

The control set 30 is for example a terminal adapted for configuring the plurality of devices 10, and advantageously the remote unit 20. The control set 30 is a computer, for example of the tablet or smartphone type.

The control set 30 comprises a man-machine interface 52, such as a touch screen, a piece of configuration software 54, and a communication unit 56 adapted for sending pieces of information to the communication units 44 of the plurality of devices 10.

The piece of configuration software 54 and the man-machine interface 52 are adapted so as to allow a user to edit the configuration parameters 40 of the plurality of devices 10.

By [symbol] edit [symbol] , is meant here selecting with view to verification, inputting or modifying the configuration parameter 40.

For example, the piece of configuration software 54 and the man-machine interface 52 give the possibility of opening a window 58 for editing the configuration parameter 40 relative to the device 10A.

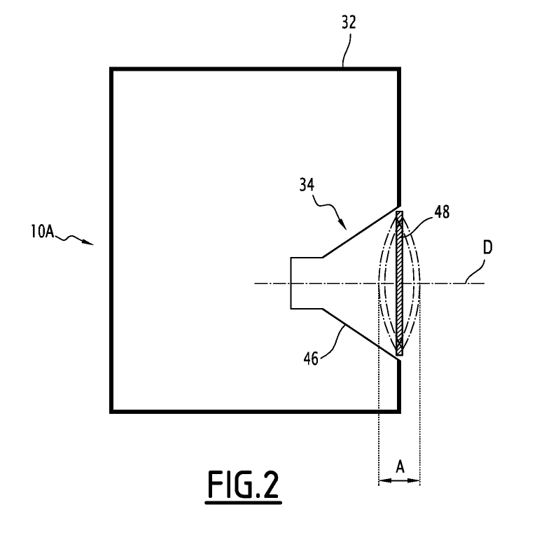

The operation of the installation 1 will now be described with reference to FIGS. 1 and 2 and on the configuration example consisting of assigning a name to each of the devices 10A, 10B of the plurality of devices 10.

The user actually sees that one of the devices 10A, 10B is located on the left relatively to the other one, while the other one of the devices 10A, 10B is located on the right. However, the user is unable to determine a priori if the device 10A is located on the right or on the left. The user nevertheless wishes to assign to the devices 10A, 10B the identification labels “left loudspeaker” and “right loudspeaker” without making a mistake.

To do this, by means of the man-machine interface 52, the user edits the configuration parameter 40 which implicitly corresponds to the device 10A. By “editing”, is meant the fact for the user of acting on the control set 30 so as to be able to read, input, or modify the configuration parameter 40.

For example, the editing window 58 is initially empty. However, the control set 30 detects that the user selects the editing window 58 relatively to the configuration parameter 40 of the loudspeaker 10A.

The control set 30 then provides a parameter for identification of the device for which the configuration parameter is edited, i.e. of the device 10A.

The control set 30 then sends a signal 60 for requesting identification by means of the communication unit 56.

The signal 60 is advantageously transmitted via electromagnetic waves, for example transits through a radio link according to the IEEE 802.11 standard, or else transits through a wired connection of the Ethernet or PLC type.

The signal 60 contains the identification parameter provided by the control set.

The devices 10A, 10B of the plurality of devices 10 receive the signal 60 and the identification parameter. Each device 10A, 10B compares the received identification parameter with the identifier 38 contained in its memory 36 for obtaining a comparison result.

If the comparison result corresponds to the identifier 38 stored in its memory 36, the device 10A emits a visual signal as beats of its membrane 48.

The beats of the membrane 48 are detected by the user as coming from the device 10A, which allows the user to identify that he/she is editing an identification label of the device 10A. The user then ascertains that the device for which the membrane 48 is performing beats, is respectively located on the left or on the right of the device not emitting such a signal and inputs into the window 58, respectively, the identification label “left loudspeaker”, or “right loudspeaker”.

When editing of the configuration parameter 40 stops, the device 10A stops emitting said visual signal.

Alternatively, the device 10A stops emitting the visual signal after a predetermined duration.

According to another embodiment, the device 10A does not emit a visual signal, but a sound signal depending on the comparison result, i.e. a sound wave obtained by movements of the membrane, for which the frequency is greater than or equal to 20 Hertz.

According to another embodiment, depending on the comparison result, the device 10A emits both the aforementioned visual signal and the sound signal.

It is obvious that from what has been said of the device 10A in response to the comparison result is transposed to the device 10B.

According to other embodiments, the configuration parameter 40 edited by the user is an operating parameter of the device 10A, such as a representative threshold of a maximum sound volume.

By means of the features described above, the installation 1 allows the user to identify the device from the plurality of devices 10, for which he/she is editing a configuration parameter. This allows the user to decide knowingly which values he/she wishes to give to the configuration parameters 40 and of the plurality of devices 10.

According to an embodiment not shown, the communication units 44, 50, 56 communicate with each other through a wired network of the Ethernet or PLC type.

1. A method comprising
a plurality of devices which may be connected to at least one remote unit, each device comprising a memory storing at least one identifier of the device, and at least one configuration parameter representative of a configuration of the device, and
a control set adapted for remotely controlling the devices, the control set comprising at least one man-machine interface,
the method further comprising the steps of:
selecting by a user of any of the configuration parameters by means of the man-machine interface,
detecting by the control set that the configuration parameter is selected and providing by the control set of an identification parameter of the device corresponding to the configuration parameter,
transmitting by the control set of a signal for requesting identification containing the identification parameter,
receiving by each device of the signal and the identification parameter,
comparing by each device of the received identification parameter with the identifier contained in the memory of the device in order to obtain a comparison result, and
emitting by the device of a sound or a visual signal if the comparison result is that the received identification parameter corresponds to the identifier.

2. The method according to claim 1, wherein the devices of the plurality of devices have a similar external aspect to each other for the user.

3. The method according to claim 1, wherein each device of the plurality of devices is without any screen for displaying the configuration parameter of the device.

4. The method according to claim 1, wherein each of the devices of the plurality of devices comprises a loud speaker.

5. The method according to claim 4, wherein each device comprises at least one membrane able to emit sound waves, the visual signal comprising the beats of the membrane detectable to the eye by the user.

6. The method according to claim 5, wherein the beats of the membrane have a non-zero frequency and less than or equal to 20 Hz.

7. The method according to claim 1, wherein the selected configuration parameter is an identification label of the device intended for the user, an operating parameter of the device, or a position parameter of the device relatively to at least one other one of the devices of the plurality of devices.

8. An installation comprising:
a plurality of devices which may be connected to at least one remote unit, each device comprising a memory adapted for storing at least one identifier of the device, and at least one configuration parameter representative of a configuration of the device, and
a control set for remotely controlling the plurality of devices, the control set comprising at least one man-machine interface adapted so that a user selects any of the configuration parameters,
the control set being adapted for:
detecting that a user selects the configuration parameter,
providing an identification parameter of the device for which the configuration parameter is selected, and
sending a signal for requesting identification containing the identification parameter,
each device being adapted for:
receiving the signal and the identification parameter,
comparing the received identification parameter with the identifier contained in the memory of the device and obtaining a comparison result, and
emitting a sound or a visual signal if the comparison result is that the received identification parameter corresponds to the identifier.

9. The method according to claim 6, wherein the non-zero frequency is less than or equal to 15 Hz.
